(19) United States
(12) Patent Application Publication
(10) Pub. No.: US 2007/0117566 A1
(43) Pub. Date: May 24, 2007

(54) System and method for reducing a forced neighbor cell procedure

(76) Inventors: Jean Khawand, Miami, FL (US); Philip A. Schentrup, Hollywood, FL (US); Todd M. Russell, Coral Springs, FL (US); Kelley S. Block, Coral Springs, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/285,585

(22) Filed: Nov. 21, 2005

(51) Int. Cl. H04Q 7/20

(52) U.S. Cl. 455/446

(57) ABSTRACT

The invention concerns a method (300, 500) and system (112) for reducing a forced neighbor cell procedure. The method can include the steps of—in a mobile unit (112) on a communications channel (400, 600)—monitoring (312, 512) one or more neighbor cell parameters and performing (314, 514) a neighbor cell measurement in a selectively generated opportunity in the communications channel to reduce the possibility that the mobile unit will enter a forced neighbor cell measurement.

### BACKGROUND OF THE INVENTION

1. Field of the Invention

The present invention concerns communications management and more particularly, management of neighbor cell measurements.

2. Description of the Related Art

In most communications systems, a number of communications stations, such as base stations, are used to relay wireless signals to mobile units, like cellular telephones, two-way radios or personal digital assistants. While a mobile unit is communicating with the base station that is currently serving it, the mobile unit will monitor certain parameters of neighboring base stations, or neighbor cells. As an example, one parameter may be signal strength measurements of the neighbor cells, and the mobile unit can constantly monitor them to determine which neighbor cell is best for a handover.

If the mobile unit is sending or receiving heavy amounts of data, however, the mobile unit may not have enough time to perform the neighbor cell measurements. As such, the mobile unit may build up a deficit of these measurements. Once this deficit reaches a predetermined point, the mobile unit may force itself to perform a neighbor cell measurement, at least until the measurement deficit is alleviated to an acceptable level. Unfortunately, this forced measurement, sometimes referred to as forced neighbor cell, has a detrimental effect on packet data throughput. In particular, forced neighbor cell limits throughput for users and also wastes overall channel bandwidth because any outbound data from the network to the mobile unit is not received by the mobile unit and must be resent.

### SUMMARY OF THE INVENTION

The present invention concerns a method for reducing a forced neighbor cell procedure. The method can include the steps of—in a mobile unit on a communications channel—monitoring one or more neighbor cell parameters and performing a neighbor cell measurement in a selectively generated opportunity in the communications channel to reduce the possibility that the mobile unit will enter a forced neighbor cell measurement. As an example, the neighbor cell parameter can be a signal strength or an indication as to a type of data that can be exchanged.

In one arrangement, the communications channel can include a reservation request slot having a first subslot and a second subslot. In addition, the opportunity can be selectively generated by only selecting the first subslot of the reservation request slot for a reservation request and avoiding the second subslot for the reservation request. Avoiding the second subslot for the reservation request can create an additional window for performing the neighbor cell measurement. The communications channel can be a half-duplex communications channel having transmission and receive slots in which the transmission and receive slots may be temporally offset. The method can also include the step of counting for a predetermined number of slots and only selecting the first subslot of the reservation request slot for the reservation request and avoiding the second subslot for the reservation request if a transmission request is received during the counting of the predetermined number of slots.

In another arrangement, the opportunity can be selectively generated in the communications channel by modifying a channel allocation slot in the communications channel. As an example, the channel allocation slot can be a dynamic channel allocation procedure slot, and modifying the channel allocation slot can include setting a counter in the dynamic channel allocation procedure slot. Setting the counter can include setting the counter to a predetermined value to indicate that a slot map for a number of dynamic channel allocation procedure frames may not change. This number can correspond to the predetermined value. In addition, performing the neighbor cell measurement can include performing the neighbor cell measurement during dynamic channel allocation procedure slots in at least one of the dynamic channel allocation procedure frames that may not change. As an example, the channel allocation slot in the communications channel can be modified by a communications network that is communicating with the mobile unit.

The present invention also concerns a system for reducing a forced neighbor cell procedure. The system can include a receiver that receives wireless signals over a communications channel and a processor coupled to the receiver. The processor can be programmed to monitor one or more neighbor cell parameters and to perform a neighbor cell measurement in a selectively generated opportunity in the communications channel to reduce the possibility that the mobile unit will enter a forced neighbor cell measurement. In addition, the processor can be programmed to perform any of the processes described above.

The present invention also concerns a machine readable storage having stored thereon a computer program having a plurality of code sections executable by a mobile unit. The program can cause the mobile unit to perform the steps of monitoring on a communications channel one or more neighbor cell parameters and performing a neighbor cell measurement in a selectively generated opportunity in the communications channel to reduce the possibility that the mobile unit will enter a forced neighbor cell measurement. The program can also cause the mobile unit to perform any of the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a communications network and several mobile units in accordance with an embodiment of the inventive arrangements;

FIG. 2 illustrates a block diagram of a mobile unit in accordance with an embodiment of the inventive arrangements;

FIG. 3 illustrates a method of reducing a forced neighbor cell procedure in accordance with an embodiment of the inventive arrangements;

FIG. 4 illustrates a communications channel in accordance with an embodiment of the inventive arrangements;

FIG. 5 illustrates another method of reducing a forced neighbor cell procedure in accordance with an embodiment of the inventive arrangements; and

FIG. 6 illustrates another communications channel in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “coupled” and “engagement,” as used herein, are defined as connected, although not necessarily directly, and not necessarily mechanically. The term “module” can be defined as any combination of hardware and/or software to enable an appropriate function to be performed.

The terms “program,” “application,” and the like as used herein, are defined as a sequence of instructions designed for execution on a computer system. A program, computer program, or application may include a subroutine, a function, a procedure, an object method, an object implementation, an executable application, an applet, a servlet, a source code, an object code, a shared library/dynamic load library and/or other sequence of instructions designed for execution on a computer system. Where suitable, the term “application” may even refer to a hardware setting or component.

The present invention concerns a method and system for reducing a forced neighbor cell procedure. In one arrangement, the method can include the steps of—in a mobile unit on a communications channel—monitoring one or more neighbor cell parameters and performing a neighbor cell measurement in a selectively generated opportunity in the communications channel to reduce the possibility that the mobile unit will enter a forced neighbor cell measurement.

The communications channel can include a reservation request slot having a first subslot and a second subslot. As an example, the opportunity can be selectively generated by only selecting the first subslot of the reservation request for a reservation request and avoiding the second subslot for the reservation request. Avoiding the second subslot for the reservation request can create an additional window for the neighbor cell measurement.

Alternatively, the opportunity can be selectively generated in the communications channel by modifying a channel allocation slot in the communications channel. For example, the channel allocation slot can be a dynamic channel allocation procedure slot, and the channel allocation slot can be modified by setting a counter in the dynamic channel allocation procedure slot. As another example, the counter can be set to a predetermined value to indicate that a slot map for a number of dynamic channel allocation procedure frames will not change, and the number can correspond to the predetermined value. Also, the neighbor cell measurement can be performed during dynamic channel allocation procedure slots in at least one of the dynamic channel allocation procedure frames that will not change. Performing these additional neighbor cell measurements in view of these newly-generated opportunities can help prevent the build-up of a neighbor cell measurement deficit.

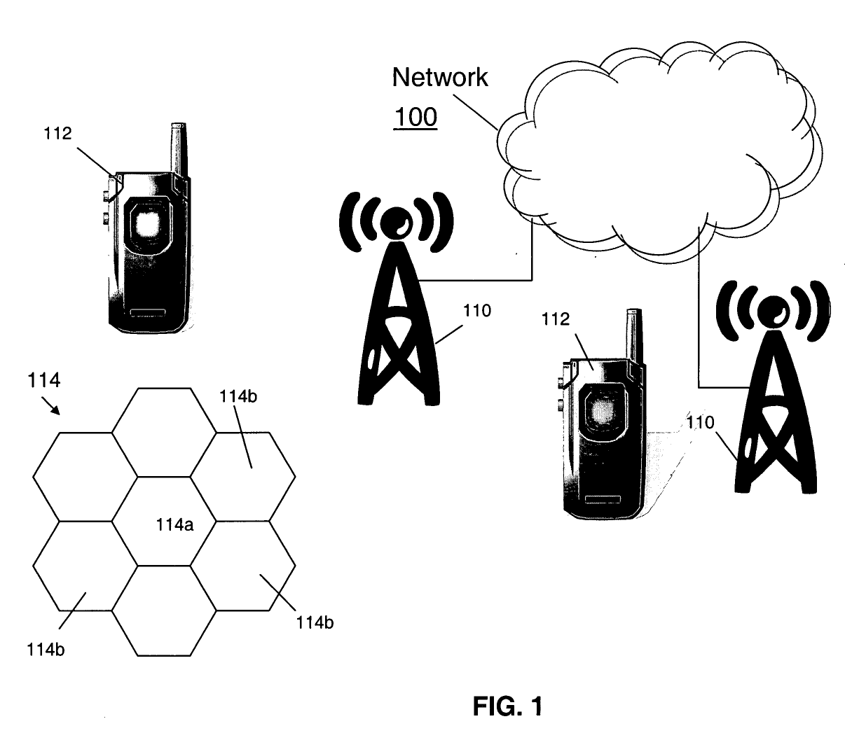

Referring to FIG. 1, a communications network 100 having one or more base stations 110 is shown. As is known in the art, the base stations 110 can wirelessly communicate with one or more mobile units 112. As an example, the mobile units 112 may be iDEN radios manufactured by Motorola, Inc. of Schaumburg, Ill., which are capable of communicating in both dispatch and interconnect modes. It is understood, however, that the invention is not so limited, as the mobile units 112 can be any other device that can receive wireless signals.

As is also known in the art, the communications network 100 can include a plurality of cells 114, each of which may include a base station 110. As an example, a mobile unit 112 may be within the boundaries of a serving Cell 114a, and the base station 110 inside the serving cell 114a can communicate with the mobile unit 112. The mobile unit 112, however, monitors one or more parameters of one or more neighboring cells 114b to enable a handover procedure to be conducted when necessary. As an example, the parameter can be a signal strength or an indication as to a type of data that can be exchanged with a base station 110 in a particular cell 114, although other suitable parameters are contemplated by the inventive arrangements.

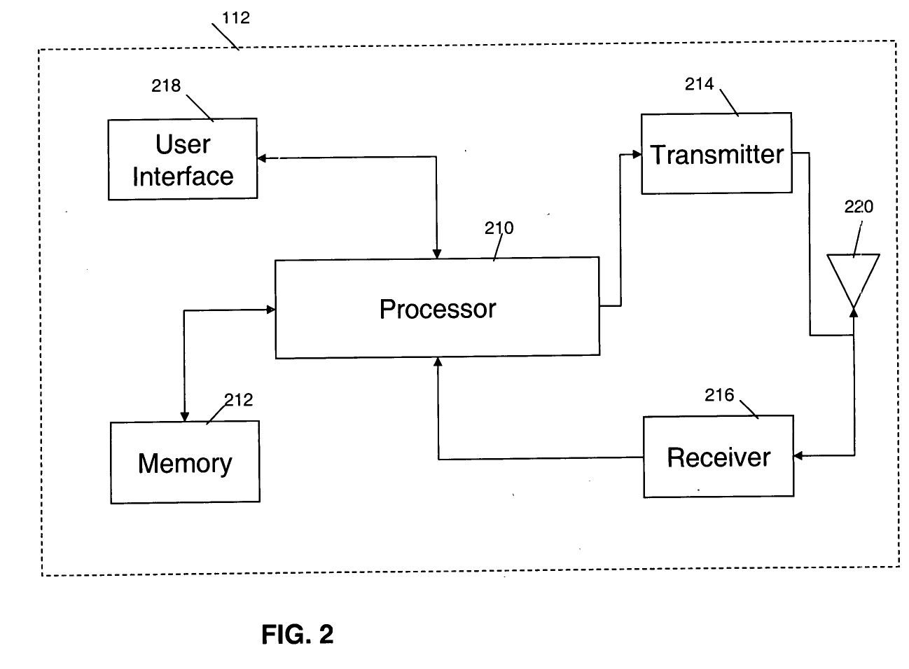

Referring to FIG. 2, an example of a block diagram of a mobile unit 112 is shown. In this example, the mobile unit 112 can include one or more of the following: a processor 210, a memory 212, a transmitter 214, a receiver 216, a user interface 218 and an antenna 220. The processor 210 can be coupled to, control the operation of and/or receive signals or information from the memory 212, the transmitter 214, the receiver 216 and the user interface 218. In addition, the transmitter 214 and the receiver 216 can be coupled to the antenna 220, which can transmit signals to and receive signals from the base stations 110 (see FIG. 1).

For purposes of the invention, the term processor can include any suitable number of components capable of executing instructions to perform the processes associated with the inventive arrangements. In addition, although the memory 212 is shown as a discrete component, it may actually be part of or integrated with the processor 210. The user interface 218 can be, for example, a keypad or a display and can receive input from a user and can signal the processor 210 with such input. In addition, the memory 212 can be any suitable type of memory for storing any suitable type of data for operation of the mobile unit 112.

In one arrangement, the processor 210 can be programmed to perform measurements of the neighbor cells 114b (see FIG. 1) in windows or opportunities that are selectively created in a communications channel through over which the mobile unit 112 is communicating with a base station 110 currently serving the mobile unit 112. By performing these measurements, the mobile unit 112 can ready itself for a handover to a neighboring base station 110 in a neighbor cell 114b. An opportunity can be any slot or opening in a communications channel that is suitable for performing a neighbor cell measurement. There are several examples of how these opportunities can be selectively generated, and they will be presented below.

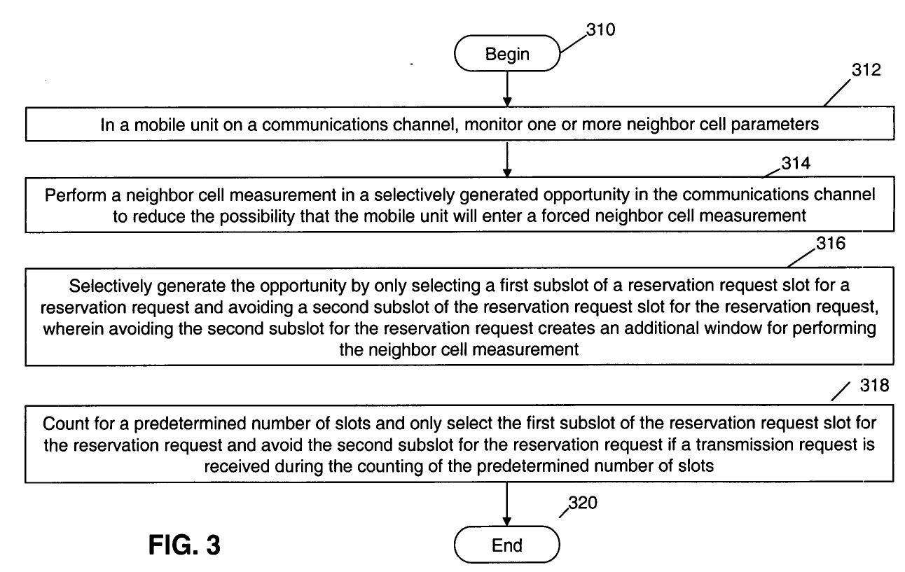

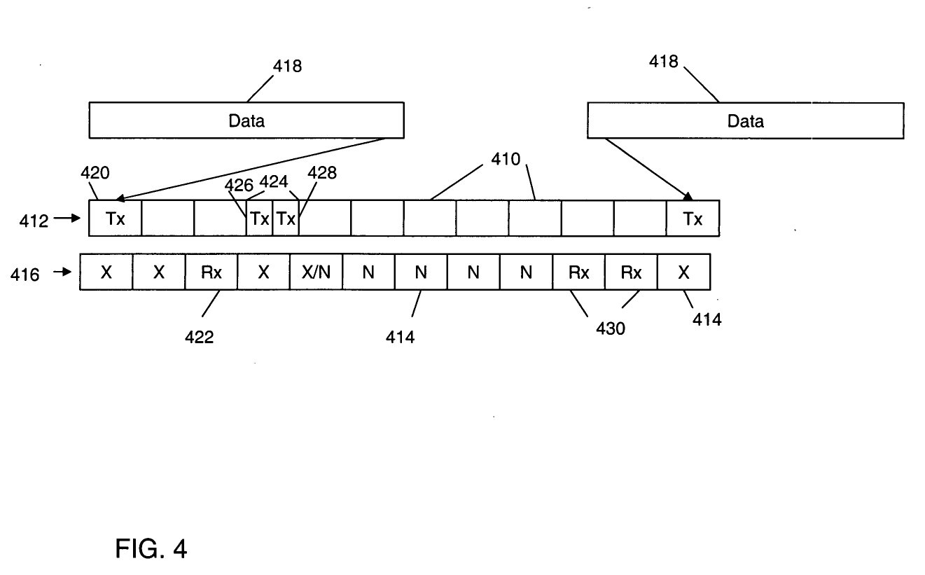

Referring to FIG. 3, a method 300 for reducing a forced neighbor cell procedure is shown. When describing the method 300, reference will be made to FIGS. 1, 2 and 4. Referring to FIG. 4, an example of a communications channel 400 having a number of transmission slots 410 in a transmission portion 412 and receive slots 414 in a receive portion 416 are shown. It must be noted, however, that the method 300 can be practiced in any other suitable system or device. Moreover, the steps of the method 300 are not limited to the particular order in which they are presented in FIG. 3. The inventive method can also have a greater number of steps or a fewer number of steps than those shown in FIG. 3.

At step 310, the method 300 can begin, and at step 312, one or more neighbor cell parameters can be monitored in a mobile unit on a communication channel. A neighbor cell measurement can be performed in a selectively generated opportunity in the communication channel to reduce the possibility that the mobile unit will enter a forced neighbor cell measurement, as shown at step 314. At step 316, the opportunity can be selectively generated by only selecting a first subslot of a reservation request slot for a reservation request and avoiding a second subslot of the reservation request slot for the reservation request. Avoiding the second subslot for the reservation request can create an additional window for performing the neighbor cell measurement.

As an option, at step 318, a predetermined number of slots can be counted. In particular, the first subslot of the reservation request subslot may only be exclusively selected for the reservation request with the second slot being avoided for the reservation request if a transmission request is received during the counting of the predetermined number of slots. The method 300 can then end at step 320.

As an example and referring to FIG. 4, the communications channel 400 can be a dispatch (i.e., half-duplex) traffic channel over which signals may be either transmitted (transmission portion 412) or received (receive portion 414) at a given time. In one arrangement, the transmission slots 410 and the receive slots 414 can be offset by a predetermined amount of time, such as 4 milli-seconds. This time is measured from the end of, for example, a receive slot 414 to the beginning of a transmission slot 412. This timing offset exists to accommodate the time needed for the mobile unit 112 to switch between transmit and receive operations.

Referring now to FIGS. 1, 2 and 4, the mobile unit 112 can be communicating with a base station 110 in the serving cell 114a over the communication channel 400. The mobile unit 112 can monitor one or more parameters, such as signal strength, of one or more neighbor cells 114b.

As an example, the mobile unit 112 may begin transmitting data, such as a clip of video or audio file. As is known in the art, the data being transmitted may be transmitted to the base station 110 in stages, which can be represented by blocks of data 418. Each block of data 418 may be made of a predetermined number of slots, and the mobile unit 112 may perform a reservation request with the base station 110 to transmit another block of data 418. For example, the first block of data 416 on the left of FIG. 4 may be transmitted from the mobile unit 112, and its last transmission slot 420 is shown in the transmission portion 412. Because the communications channel 400 may be a half-duplex channel, the receive slots 414 with an “X” inserted in them can represent receive slots 414 over which no signal may be received from the base station 110 because at least a portion of the transmission slot 420 is on the communication channel 400 at that time.

The next available receive slot 414 in the receive portion 416 can be an availability slot 422, which can indicate to the mobile unit 112 that the communications channel 400 is available for transmitting. The next available transmission slot 410 can be referred to as a reservation request slot 424, which can have a first subslot 426 and a second subslot 428. The processor 210 of the mobile unit 112 can use the reservation request slot 424 as a request to reserve the communications channel 400 to transmit, for example, the next or second block of data 418, which is shown on the right of FIG. 4.

In one arrangement, the reservation request slot 424 may be a packet channel random access procedure (PRAP) slot. Normally, the processor 210 can randomly select either the first subslot 426 or the second subslot 428 for the reservation request. By randomly selecting the first subslot 426 or the second subslot 428, the likelihood of a collision with a reservation request from other mobile units 112 can be reduced. In those instances where the second subslot 428 is selected, the receive slots 414 that overlap the second subslot 428 are unavailable (they are marked with an “X” and an “X/N”).

In accordance with one embodiment of the inventive arrangements, the processor 210 can be programmed to only select the first subslot 426 of the reservation request slot 424 when sending the reservation request. As such, selecting the second subslot 428 to send the reservation request can be avoided, which can create an additional window for a neighbor cell measurement. In particular, the first subslot 426 may only overlap one receive slot 414, instead of the two receive slots 414 that the second subslot 428 overlaps. As such, one of the two receive slots 414 (the one designated with the “X/N”) can be used as a neighbor cell measurement slot. That is, the processor 210 can be programmed to perform a neighbor cell measurement during this newly-generated opportunity in the communication channel 400. This additional neighbor cell measurement can help reduce a neighbor cell deficit, if one has formed, which is possible when transmitting the blocks of data 418.

The processor 210 can also perform neighbor cell measurements in the receive slots 414 following the newly-generated slot, which can be designated by “N,” at least until a reservation grant 430 has been received by the mobile unit 112. At this point, the processor 210 can instruct the transmitter 214 to begin transmitting the next block of data 418 at the next available transmission slot 410.

In one arrangement, the processor 210 may be programmed to count a predetermined number of slots and to select the first subslot 426 in accordance with the discussion above only if a transmission request is received during the counting of the predetermined number of slots. For example, from the end of the last transmission slot 410 of the first block of data 418, the processor 210 can be programmed to count, for example, ten slots. If the processor 210 receives a transmission request during this time, the processor 210 can select only the first subslot 426 for the transmission of the reservation request and can avoid the second subslot 428. This situation is what has occurred in the example described above, as the second block of data 418 needed to be transmitted.

If no transmission request is received during this counting process, however, the processor 210 can be programmed to revert to the random selection of either the first subslot 426 or the second subslot 428 to transmit the reservation request. The predetermined count process is entirely optional and is by no means limited to ten slots. Nonetheless, following this procedure can strike a balance between reducing forced neighbor cell measurements and avoiding collisions through the random selection of the first subslot 426 and the second subslot 428.

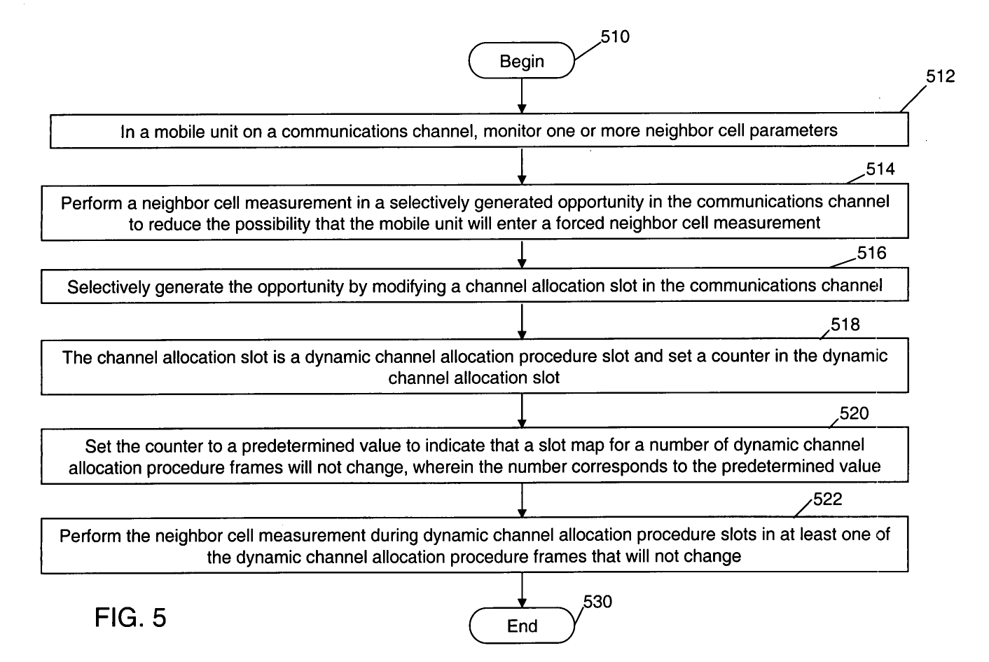

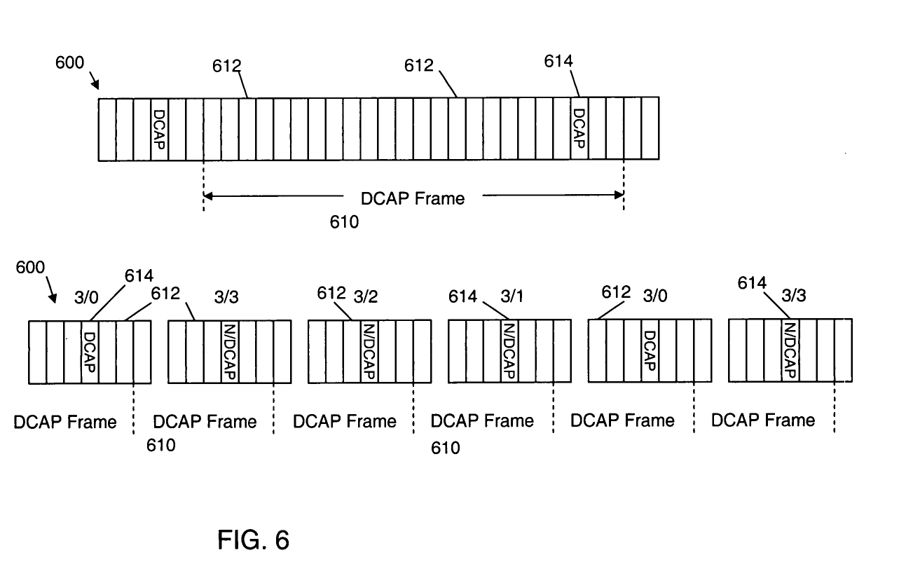

Referring to FIG. 5, a method 500 illustrating another way to reduce a forced neighbor cell procedure is shown. When describing the method 500, reference will be made to FIGS. 1, 2 and 6. Referring to FIG. 6, an example of a communications channel 600 having a number of DCAP frames 610 is shown. It must be noted, however, that the method 500 can be practiced in any other suitable system or device. Moreover, the steps of the method 500 are not limited to the particular order in which they are presented in FIG. 5. The inventive method can also have a greater number of steps or a fewer number of steps than those shown in FIG. 5.

At step 510, the method 300 can begin. Steps 512 and 514 are similar to steps 312 and 314 of the method 300 of FIG. 3 and will not be repeated here. At step 516, the opportunity can be selectively generated by modifying a channel allocation slot in the communications channel. At step 518, the channel allocation slot can be a dynamic channel allocation procedure (DCAP) slot, and a counter in the DCAP slot can be set. This counter can be set to a predetermined value to indicate that a slot map for a number of DCAP frames will not change in which the number corresponds to the predetermined value, as shown at step 520. At step 522, the neighbor cell measurement can be performed during DCAP slots in at least one of the DCAP frames that will not change. The method 500 can stop at step 530.

For example, referring to FIG. 6, a communications channel 600 is shown. This communications channel 600 may be a packet channel capable of carrying both voice and data. In one arrangement, the communications channel 600 can include any suitable number of DCAP frames 610. The top communications channel 600 shown in FIG. 6 illustrates an example of one DCAP frame 610, while the bottom communications channel 600 shows several annotated DCAP frames 610.

As an example, the DCAP frame 610 can include a suitable number of contiguous slots 612 that carry voice and/or data. In our example, the number of slots 612 can be twenty-four, which is shown in the top DCAP frame 610, although the DCAP frames 610 can certainly contain any other suitable number of slots 612, including multiples of twenty-four. As another example, each DCAP frame 610 can include one or more channel allocation slots or DCAP slots 614. As is known in the art, a DCAP slot 614 in a DCAP frame 610 can inform a mobile unit 112 of the slot allocation of the next DCAP frame 610. As a result, the mobile units 112 on the communication channel 600 may receive and process the DCAP slots 614 to determine slot allocations in upcoming DCAP frames 610. The communications network 100 (see FIG. 1) can use the DCAP slots 614 to dynamically remove slots 612 that are designated for data and assign them to non-data users, such as for interconnect or dispatch callers.

Referring now to FIGS. 1, 2 and 6, the communications network 100 can modify the DCAP slots 614 to selectively generate an opportunity for the mobile unit 112 to perform a neighbor cell measurement. As an example, this modification can be performed at the base stations 110 or at some other component of the network 100. In one arrangement, a counter can be incorporated into the DCAP slots 614, and the network 100 can set these counters to a predetermined value. The sets of numbers positioned above the DCAP slots 614 in FIG. 6 can represent examples of these predetermined values. There are at least two ways that the predetermined values can be set, and they will now be presented. Those of skill in the art will appreciate, however, that the invention is not limited to these particular examples, as other alternatives for setting the counter may be used here.

In the first example, the slots 612 of the communications channel 600 may be carrying voice or data packets, and the network 100 can determine that the slot maps for a number of the DCAP frames 610 may not change. At this point, the mobile unit 112 can perform neighbor cell measurements in the DCAP slots 614 of at least some of the DCAP frames 610 that may not change.

For example, the network 100 can set the counter to a value of “3,” which is the value above the DCAP slots 614 to the left of the forward slash symbol. The mobile units 112 that receive the DCAP slots 614 with a counter value of 3 can then use the next three DCAP slots 614 to perform a neighbor cell measurement after conventionally reading a DCAP slot 614. The DCAP slots 614 that may be used for this purpose are shown marked with “N/DCAP,” where the “N” means that the mobile stations 112 can perform a neighbor cell measurement at this DCAP slot 614. So, in this example, the mobile unit 112 can read the first DCAP slot 614 (from the left) and can determine that neighbor cell measurements can be performed at the next three DCAP slots 614.

This predetermined value can be changed at any time, and is by no means limited to a value of three. Also, it is understood that not all the mobile units 112 will conventionally read the same DCAP slot 614 and perform the neighbor cell measurements on the same three DCAP slots 614. For example one mobile unit 112 may read the first DCAP slot 614—labeled as “3/0”—and perform neighbor cell measurements for the next three DCAP slots 614—labeled as “3/3,” “3/2” and “3/1,” respectively. Another mobile unit 112, for example, may read the DCAP slot 614 labeled as “3/3” and then perform neighbor cell measurements for the next three DCAP slots 614, or “3/2,” “3/1” and “3/0.” In either arrangement, because the mobile units 112 are informed that a certain number of DCAP slots 614 do not have to be read, additional opportunities for the mobile units 112 to perform neighbor cell measurements can be generated, thus reducing the chances that a forced neighbor cell measurement will occur.

In the second example, there may be an instance where the network 100 must accommodate a non-data service request, such as an interconnect or dispatch call. These types of requests are typically given priority by the network 100, and as such, the network 100 may need to reassign slots 612 to facilitate the call. As such, the network 100 may signal the mobile units 112 that the slot maps of the data frames 614 may change. In one arrangement, the network 100 can change the setting of the counter to begin a countdown, and these values are represented by the number to the right of the forward slash above the DCAP slots 614. As such, when a mobile unit 112 conventionally reads a DCAP slot 614, the mobile unit 112 can determine that it should read an upcoming DCAP slot 614 in view of the change of the slot map for an upcoming DCAP frame 610.

For example, if a mobile unit 112 conventionally reads the DCAP slot 614 with the counter value on the right of the forward slash being “2” (third DCAP slot 614 from the left), then the mobile unit 112 may read the DCAP slot 614 with the counter value of “0” to the right of the forward slash (fifth DCAP slot 614 from the left). This process can instruct all the mobile units 112 of the upcoming change, even though they may not all be reading the same DCAP slot 614 during the process described above. Again, it must be noted that the invention is in no way limited to these values.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for reducing a forced neighbor cell procedure, comprising:
in a mobile unit on a communications channel, monitoring one or more neighbor cell parameters; and
performing a neighbor cell measurement in a selectively generated opportunity in the communications channel to reduce the possibility that the mobile unit will enter a forced neighbor cell measurement.

2. The method according to claim 1, wherein the neighbor cell parameter is a signal strength or an indication as to a type of data that can be exchanged.

3. The method according to claim 1, wherein the communications channel includes a reservation request slot having a first subslot and a second subslot and wherein the opportunity is selectively generated by only selecting the first subslot of the reservation request slot for a reservation request and avoiding the second subslot for the reservation request, wherein avoiding the second subslot for the reservation request creates an additional window for performing the neighbor cell measurement.

4. The method according to claim 3, wherein the communications channel is a half-duplex communications channel having transmission and receive slots in which the transmission and receive slots are temporally offset.

5. The method according to claim 3, further comprising counting for a predetermined number of slots and only selecting the first subslot of the reservation request slot for the reservation request and avoiding the second subslot for the reservation request if a transmission request is received during the counting of the predetermined number of slots.

6. The method according to claim 1, wherein the opportunity is selectively generated in the communications channel by modifying a channel allocation slot in the communications channel.

7. The method according to claim 6, wherein the channel allocation slot is a dynamic channel allocation procedure slot and modifying the channel allocation slot comprises setting a counter in the dynamic channel allocation procedure slot.

8. The method according to claim 7, wherein setting the counter comprises setting the counter to a predetermined value to indicate that a slot map for a number of dynamic channel allocation procedure frames will not change, wherein the number corresponds to the predetermined value.

9. The method according to claim 8, wherein performing the neighbor cell measurement comprises performing the neighbor cell measurement during dynamic channel allocation procedure slots in at least one of the dynamic channel allocation procedure frames that will not change.

10. The method according to claim 6, wherein the channel allocation slot in the communications channel is modified by a communications network that is communicating with the mobile unit.

11. A system for reducing a forced neighbor cell procedure, comprising:
a receiver that receives wireless signals over a communications channel; and
a processor coupled to the receiver, wherein the processor is programmed to:
monitor one or more neighbor cell parameters; and
perform a neighbor cell measurement in a selectively generated opportunity in the communications channel to reduce the possibility that the mobile unit will enter a forced neighbor cell measurement.

12. The system according to claim 11, wherein the communications channel includes a reservation request slot having a first subslot and a second subslot and wherein the processor is further programmed to selectively generate the opportunity by only selecting the first subslot of the reservation request for a reservation request and avoiding the second subslot for the reservation request, wherein avoiding the second subslot for the reservation request creates an additional window for the neighbor cell measurement.

13. The system according to claim 12, wherein the processor is further programmed to count for a predetermined number of slots and to only select the first subslot of the reservation request slot for the reservation request and to avoid the second subslot for the reservation request if a transmission request is received during the counting of the predetermined number of slots.

14. The system according to claim 11, wherein the opportunity is selectively generated in the communications channel by modifying a channel allocation slot in the communications channel.

15. The system according to claim 14, wherein the channel allocation slot is a dynamic channel allocation procedure slot and the channel allocation slot is modified by setting a counter in the dynamic channel allocation procedure slot, wherein a communications network in communication with the receiver sets the counter.

16. The system according to claim 15, wherein the communications network sets the counter to a predetermined value to indicate that a slot map for a number of dynamic channel allocation procedure frames will not change, wherein the number corresponds to the predetermined value.

17. The system according to claim 16, wherein the processor is further programmed to perform the neighbor cell measurement during dynamic channel allocation procedure slots in at least one of the dynamic channel allocation procedure frames that will not change.

18. A machine readable storage, having stored thereon a computer program having a plurality of code sections executable by a mobile unit for causing the mobile unit to perform the steps of:
monitoring on a communications channel one or more neighbor cell parameters; and
performing a neighbor cell measurement in a selectively generated opportunity in the communications channel to reduce the possibility that the mobile unit will enter a forced neighbor cell measurement.

19. The machine readable storage according to claim 18, wherein the communications channel includes a reservation request slot having a first subslot and a second subslot and wherein the opportunity is selectively generated by only selecting the first subslot of the reservation request for a reservation request and avoiding the second subslot for the reservation request, wherein avoiding the second subslot for the reservation request creates an additional window for the neighbor cell measurement.

20. The machine readable storage according to claim 18, wherein the opportunity is selectively generated in the communications channel by modifying a channel allocation slot in the communications channel.
